(19) United States
(12) Patent Application Publication
(10) Pub. No.: US 2009/0011392 A1
(43) Pub. Date: Jan. 8, 2009

(54) SAT Word Cards

(76) Inventor: Samson Huang, (US)

Correspondence Address: Samson Huang, P.O.Box 269, Towaco, NJ, 07082, US

(21) Appl. No.: 11/773,937

(22) Filed: Jul. 5, 2007

(51) Int. Cl. G09B 19/00

(52) U.S. Cl. 434/167

(57) ABSTRACT

A set of word cards for teaching students specific words in preparing for the SAT. These word cards provide a method of learning SAT words by utilizing a word's part of speech, definition, spelling, and usage in a sentence. The cards assist a student in self-learning as well as self-checking when learning words. The matching letters on either side of the word cards provides a way of self-checking. The answer is found by matching the letters on one side of the word card with the letters on the reverse side of that same word card.

### BACKGROUND

1. Field of Invention

This invention relates to a method of self-learning and self-checking in order to learn or review SAT (or uncommonly used) words through the use of SAT Word Cards.

2. Description of Prior Art

Word games utilizing various methods of learning or reviewing vocabulary have been proposed in the prior art. Such word-forming games may include a deck of cards with letters printed thereon have been presented in U.S. Pat. Nos. 4,262,431; 4,402,513; 4,826,175; 4,923,199; 5,014,996, and 6,234,486.

A sentence-forming game has been shown in U.S. Pat. No. 3,618,231 to Nason (1971). U.S. Pat. No. 6,120,297 to Morse (2000) provides a system for increasing the vocabulary of a student using inductive reasoning by providing informal clues other than the formal definition or sentence to learn a new word. Other examples of word games may involve board games for learning words (see U.S. Pat. Nos. 4,021,937; 4,940,239 and 4,973,058) and card games for learning a foreign language (see U.S. Pat. Nos. 3,602,513; 4,973,058, and 5,788,502).

The inventions disclosed in the prior art have included software-training systems for students to learn words, definitions, grammar, and sentences. These inventions include U.S. Pat. Nos. 4,403,965; 4,406,626; 5,256,067; 5,575,659, and 6,077,085, 6,343,935)

All the word cards and games disclosed in the prior art have each provided different ways of learning from the dictionary, a way of memorizing that is passive and difficult to remember in the long run. None of the word cards and games disclosed in the prior art has provided a way of preventing a student from cheating by checking the answer which may be simply on the back of the card. Players are guided through a passive and incomplete process of learning and memorizing words and definitions that may not be fully understood.

Word cards and games have been used for students to learn and review words in different levels. Many inventions and products in the market have provided students with useful and fun materials for expanding their vocabulary. SAT word testing requires test takers to have a higher level of understanding of words, their meaning, and usages.

Therefore, there is a great need for providing SAT learners with a novel and improved word cards focusing on the completion of spelling, meaning and sentence. There has further been a need for discovering their learning potentials and wonders in an active and complete process of expanding their SAT vocabulary. There also has been a need to improve their learning quality in a logical and natural environment.

### SUMMARY OF INVENTION

It is a principal objective of the present invention to provide an active and complete way of learning and acquiring many new words. This invention focuses on putting the process of learning words in the logical context of definition and sentence. A word is learned in its entirety by its part of speech, spelling, definition, and usage in a sentence. The invention physically allows SAT learners to learn and review SAT words in a productive and creative fashion.

Another object of this invention is to provide a novel and improved set of word cards, which can be used for self-learning as well as for self-checking. The letters of a word on one side of the card serves as the answer for the missing letters on the reverse side.

In accordance with the present invention, the above objective is achieved by providing a set of word cards involving spelling, definition, and sentence usage of words by those using the cards. In the present invention, there is provided at least one word card and preferably, a plurality of such word cards. Each word card consists of a target word that is broken up into matching letters on either side. The part of speech, definition, and part of the target word imprinted on one side thereof and a sentence using different letters of the target word on the reverse side thereof. The word which is imprinted on any particular word card is different and distinct from the words on the other word cards. Some letters of the word are left out in order to ensure a better understanding of the spelling of the word by stimulating the mind. The matching letters of the word on one face serves as the answer for the missing letters of the word left out on the reverse face.

Further objects and advantages are to provide the student with an active process of learning new words. The student will participate in developing a full understanding and reasoning of words with the application of definition and sentences. There are two ways in which these word cards can be used to learn words, either by its part of speech and definition or its sentence. The answer can only be found through matching the letters on one side of the card with the letters on the reverse side. It is convenient and productive.

A final object of this invention is to provide students with logical and psychological environment to learn and review uncommonly used words in their natural settings.

### DRAWING FIGURES

In the drawings:

FIG. 1 is a view of the first side of the word cards with part of the word ADAGE, “_DAG_”, with the first A and the last E left blank, the part of speech, and definition of that same word.

FIG. 2 is a view of the second side of the word cards with the part of the word adage, “a_{———}”, with the letters d, a, and g left blank, used in a sentence.

### DESCRIPTION

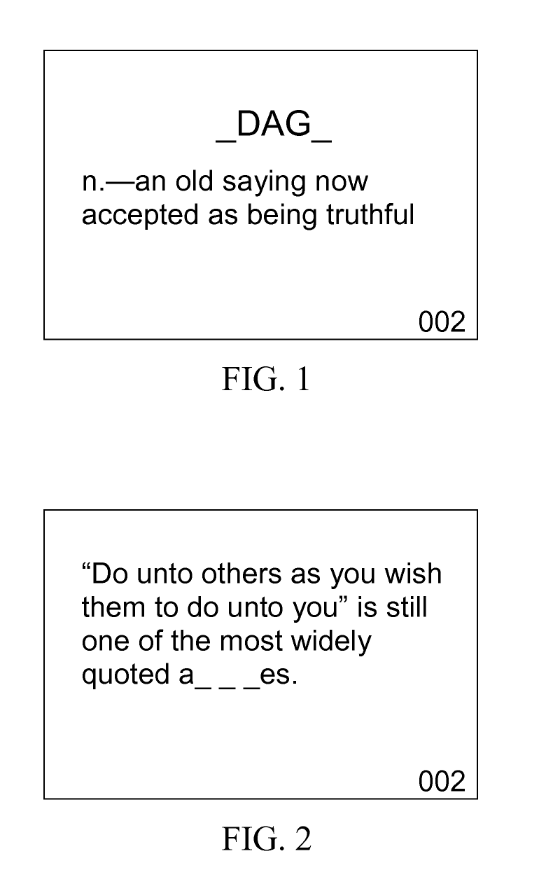

In a preferred embodiment of the invention, there is provided a set of word cards comprising any number of word cards, each card representing a distinct word. In FIG. 1 there is shown a representative word card from the set of word cards. The word cards of this invention are preferably made of plastic, plastic coated paper, or other playing card material as used in standard sets of flash cards.

The word card shown in FIG. 1 has the word “_DAG_”, its part of speech, and the definition “n.—an old saying now accepted as being truthful” printed on the first side of the card, the visible side as illustrated in FIG. 1. In FIG. 2, the reverse side of the word card is shown, with the sentence, “‘Do unto others as you wish them to do unto you’ is still one of the most widely quoted a_{———}es.” The letters on the first side of the card serves as the answer for the missing letters on the second side and vice versa. Each card also has a certain number labeled on the bottom right hand corner of either side of the card. For this specific card, the number is 002.

In another aspect of the invention, these word cards can be used for self-learning as well as self-checking and testing one's knowledge of words by providing an interesting and stimulating way of learning words. Self-learning is achieved by mastering the spelling, meaning, and usage of a word. Self-checking is achieved by matching letters on both sides of the word cards. These word cards can also be used as a deck of cards in a word game setting.

### CONCLUSION, RAMIFICATIONS, AND SCOPE

In summary, there are many inventions using different resources to improve understanding and reasoning of words, phrases, and usages. These resources include using card games, board games, software systems, and electronic devices. These inventions involve a lower level of understanding information with an informal definition. The present invention deals with a higher level of understanding and reasoning with a formal definition and exact usage of the word in a sentence.

Although preferred embodiments of the invention have been illustrated and described, it is to be understood that the present disclosure is made by way of example and that various other embodiments are possible without departing from the subject matter coming within scope of the following claims, which subject matter is regarded as the invention. For example, the word cards can be served as deck of cards for 2 to 4 players to play challenge word game with different sets of rules. In addition, the word cards in electronic formats are possible for word game players and iPod SAT learners. Therefore, the spirit and scope of the appended claims should not be limited to the description of the preferred embodiment contained herein.

What is claimed is:

1. SAT word cards comprising:
two sides of word cards;
each card having a target word with missing letters, its part of speech, and definition on a first side and a sentence using said target word with missing letters on the opposite second side;
first side of word cards having letters of said target word serving as answers of the missing letters of said target word on the opposite second side;
second side of the word cards having letters of said target word serving as answers of the missing letters of said target word on the first side.
